(19) United States
(12) Patent Application Publication
(10) Pub. No.: US 2016/0371177 A1
(43) Pub. Date: Dec. 22, 2016

(54) METHOD FOR DETERMINING AN AMOUNT OF AVAILABLE RESOURCES ENSURING A QUALITY USER EXPERIENCE

(71) Applicant: BULL SAS, Les Clayes Sous Bois (FR)

(72) Inventors: Damien AIELLO, La Buisse (FR); Wajih CHAABANE, Chambery (FR); José-Ignacio ALVAREZ-MARCOS, Saint Jean d'Ardieres (FR)

(21) Appl. No.: 15/185,876

(22) Filed: Jun. 17, 2016

(30) Foreign Application Priority Data
Jun. 18, 2015 (FR) 1555592

(51) Int. Cl. G06F 11/36

(52) U.S. Cl. CPC G06F 11/3668

(57) ABSTRACT

A method for determining an amount of available resources of a production computing infrastructure, the amount of available resources ensuring a predetermined level of user experience associated with a computing application, the application to be released on the production infrastructure, the method including:
A: consuming an initial amount of resources of a test infrastructure, on which the application is installed
B: running a load testing scenario, during which a plurality of requests are sent to the application
C: measuring a parameter quantising the user experience, as a function of a scenario report including data relating to responses to the requests
D: if the measured parameter is lower than the predetermined level of user experience: decreasing the resource consumption of the test infrastructure, and reiterating steps B, C and D
E: calculating the amount of available resources ensuring the predetermined level of user experience.

### CROSS-REFERENCE TO RELATED APPLICATIONS

This application claims priority to French Patent Application No. 1555592, filed Jun. 18, 2015, the entire content of which is incorporated herein by reference in its entirety.

### FIELD

The present invention relates to the technical field of performance tests of computing applications. The invention more particularly relates to a method for determining an amount of available resources on a production computing infrastructure, the amount of available resources ensuring a predetermined level of user experience associated with a computing application, the application being intended to be released on the production infrastructure.

### BACKGROUND

Before deploying (releasing) a computing application on a given computing infrastructure, a performance test (benchmark) step is generally necessary. This step makes it possible to determine whether the infrastructure is adapted to the application, and in particular whether its resources are sufficient to provide a satisfactory “user experience” to the application users.

By “user experience associated with a computing application”, it is meant the feeling of a user resulting from the use of the application. A number of metrics, the main of which are the response time to requests sent to the application, enable a user experience to be quantised.

In this regard, there are performance test tools or systems (or software) enabling various scenario of using an application to be simulated to deduce therefrom statistical data reflecting its performance. Among these tools, the JMeter tool can be mentioned, a free software produced by the Foundation Apache (http://jmeter.apache.org).

The JMeter tool indeed enables performance tests of computing applications to be performed according to different protocols (such as HTTP/HTTPS, SMTP, etc.). To do so, JMeter simulates the load of a plurality of users of a target computing application, and subsequently measures a number of performance metrics describing the behaviour of the application responsive to this load, especially response times representative of the user experience.

The performance test of a computing application generally takes place as part of a campaign of searching shots performed by a user terminal, on which the JMeter software is installed (or more generally, any other load testing means) to inject, according to a predefined load testing scenario, requests meant to the target computing application.

In order to perform a performance test which best represents a real use of an application released on an infrastructure, it matters that the resource consumption of the infrastructure supporting the application is taken into account during performance tests. But, to date, no test makes it possible to determine which quantity of available resources on the infrastructure enables a certain level of user experience to be ensured.

### SUMMARY

An aspect of the invention is to determine a quantity of available resources on a computing infrastructure ensuring a predetermined level of user experience for a computing application intended to be released on the infrastructure.

For this purpose, the invention relates, according to a first aspect, to a method for determining an amount of available resources of a production computing infrastructure, the amount of available resources ensuring a predetermined level of user experience associated with a computing application, the application being intended to be released on the production infrastructure.

The method includes the following steps of:

A: consuming an initial amount of resources of a test infrastructure, on which the application is installed

B: running a load testing scenario, during which a plurality of requests are sent to the application installed on the test infrastructure

C: measuring a parameter quantising the user experience, as a function of a scenario report including data relating to responses to the requests

D: if the measured parameter is lower than the predetermined level of user experience: decreasing the resource consumption of the test infrastructure, and then reiterating steps B, C and D

E: calculating an amount of available resources ensuring the predetermined level of user experience, as a function of an amount of consumed resources for which the measured parameter is higher than or equal to the predetermined level of user experience, and of a total amount of resources of the production infrastructure.

The test infrastructure is an infrastructure including resources equivalent to those of the production infrastructure. Indeed, the computing application is tested on the test infrastructure before being released on the production infrastructure.

According to the method, as long as the user experience is of a quality lower than the predetermined level, at each new iteration of the test scenario, the resource consumption of the infrastructure is decreased. Decreasing the resource consumption gradually increases the user experience until a user experience of a quality at least equal to the predetermined level is obtained.

Further to the characteristics just mentioned in the previous paragraph, the method according to an embodiment of the invention can have one or more complementary characteristics among the following ones, considered individually or according to any technically possible combinations.

According to a non-limiting embodiment, the method includes a step of determining the initial amount of resources, which is higher than or equal to an average amount of consumed resources on the production infrastructure. Indeed, it matters that the test infrastructure should be stressed at least as much as the production infrastructure, so that the computing application is tested in the closest conditions to those of the production infrastructure.

According to a non-limiting embodiment, data relating to the responses to the requests are time responses. Time responses to the requests are indeed relevant parameters for quantising the user experience.

According to a non-limiting embodiment, the method comprises a step of comparing the successive measured parameters during each iteration of step D. This enables the drift of the parameters to be analysed as a function of the variation of the resources consumed in the infrastructure.

According to a non-limiting embodiment, the amount of consumed resources is decreased by a fraction of the initial amount during step D. During each iteration of the load testing scenario, the resource consumptions therefore deviate by a configurable fraction from their initial value.

According to a non-limiting embodiment, step A is performed by running at least one program installed on the test infrastructure, triggering operations consuming resources of the test infrastructure.

According to a non-limiting embodiment, the method includes a step of filing the amount of available resources calculated in step E.

According to a non-limiting embodiment, the method includes a step of generating a test report comprising the amount of available resources calculated in step E.

The invention relates according to a second aspect to a non-transitory computer program product implemented on a storage medium, likely to be implemented within a computer processing unit, and comprising machine readable instructions for implementing the method set out above.

### BRIEF DESCRIPTION OF THE FIGURES

The invention and its different applications will be better understood upon reading the description that follows and upon examining the accompanying figures.

The figures are only given for indicating and in no way limiting purposes of the invention. The figures show:

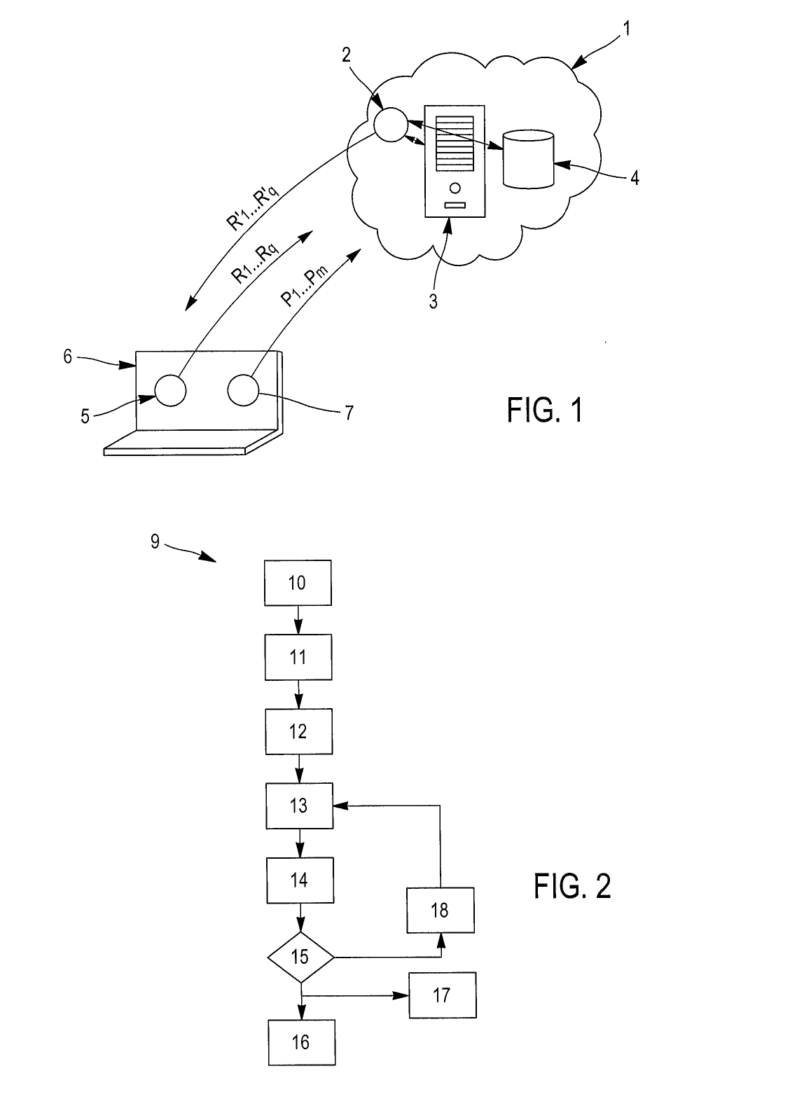

in FIG. 1, a general context of implementing the method according to one embodiment of the invention, and

in FIG. 2, steps of the method according to one embodiment of the invention.

### DETAILED DESCRIPTION

Unless otherwise specified, a same element appearing on different figures has a single reference.

FIG. 1 depicts a so-called test computing infrastructure 1, enabling a production infrastructure to be simulated, on which a computing application 2 is intended to be released. By computing infrastructure, it is meant any information system implementing one or more hardware resources, such as servers and/or databases, configured to provide several users with at least one service rendered by software resources. Therefore, in the embodiment, the computing infrastructure (production or test) is a physical structure.

The test computing infrastructure 1 therefore includes hardware and/or software resources. The test computing infrastructure comprises for example one or more interconnecting servers 3 and/or databases 4 implementing computing applications such as a Web application, an email application or a calculation platform.

A load testing system 5, installed on a user equipment 6, is configured to run a load testing scenario, in order to test the performance of the computing application 2. A computing application 2 is installed and in a testing phase on the test infrastructure 1. The load testing system 5 is the JMeter tool, any later version thereof, or, more generally, any JMeter-type load testing systems.

The user equipment 6 is a user terminal such as a computer or, more generally, any user equipment able to be connected to the test computing infrastructure 1.

The load testing scenario comprises a string of actions (or requests) R1, . . . Rq, to be run by the load testing system 5. The load testing system 5 is configured to stress, according to the load testing scenario, the test computing infrastructure 1 via a load injection to the computing application 2. The load testing system 5 therefore injects traffic (that is load) towards the hardware and/or software resources 3, 4 of the test computing infrastructure 1 which are used by the computing application 2. The load testing system consequently measures performance data of this computing application 2.

In an embodiment, the load testing system 5 includes machine executable instructions embedded in a non-transitory machine readable medium (e.g. a memory) of the user equipment 6 for carrying out the functions of the load testing system 5. For example, the load testing system 5 includes machine executable instructions for causing the user equipment 6 to send the requests and injecting traffic (that is load) towards the hardware and/or software resources 3, 4 of the test computing infrastructure 1, or for generating a report. The machine readable medium is in communication with one or more processors of the user equipment 6 for causing the one or more processors to execute the machine executable instructions.

Besides, programs 7 the running of which generate a consumption of hardware and/or software resources 3, 4 of the test infrastructure 1 are installed on the user equipment 6. For example, a program 7 configured to send data packets P1, . . . Pm on a particular port of a server 3 of the test infrastructure 1 generates consumption of a network resource.

Programs 7 make it possible to simulate a consumption of resource 3, 4 of the test infrastructure 1 which would take place in parallel with a resource consumption 3, 4 relating to a use of the computing application 2. It is therefore considered that the programs 7 enable a parasitic load to be generated on the resources 3, 4 of the test infrastructure 1, while the load testing system 5 enables a business load to be generated.

The running of programs 7 is planned: a scheduler is configured to trigger the running of the programs 7 before, simultaneously, or after launching the load testing scenario, and then to stop the running of the programs 7 at the end of the load testing scenario.

Programs 7 include machine executable instructions embedded in a non-transitory machine readable medium (e.g. a memory) of the user equipment 6 for carrying out the functions of the programs 7. For example, the programs 7 include machine executable instructions for causing the user equipment 6 to send the data packets P1, . . . Pm on the particular port of the server 3 of the test infrastructure 1 to generate consumption of a network resource. The machine readable medium is in communication with one or more processors of the user equipment 6 for causing the one or more processors to execute the machine executable instructions.

FIG. 2 depicts steps of a method 9 according to an embodiment of the invention, explained below:

According to step 10, a threshold user experience level relating to the computing application 2 is set. This level advantageously corresponds to a threshold user experience deemed satisfactory. In the embodiment described, this level is comprised of a plurality of threshold response times to the plurality of requests R1, . . . Rq of the load testing scenario. In an embodiment, the set threshold is stored in a non-transitory machine readable medium of the user equipment 6.

According to step 11, an initial amount of resources 3, 4 to be consumed on the test infrastructure 1 is set. This initial amount is at least equivalent to the one present on the production infrastructure. In an embodiment, the set initial amount of resources is stored in a non-transitory machine readable medium of the user equipment 6.

According to a step 12, the set initial amount of the resources of the test infrastructure is consumed by means of the programs 7.

According to a step 13, the load testing scenario is launched: the requests R1, . . . Rq, to the computing application 2 installed on the test infrastructure 1, are run by the load testing system 5. It is noted that step 13 can take place before, simultaneously, or after step 12. In an embodiment, the launching of the load testing scenario includes executing machine executable instructions associated with the requests and stored on one or more non-transitory machine readable medium of the user equipment 6 using one or more physical processors of the user equipment 6.

According to a step 14, the load testing system generates a test report especially comprising measurements of response times R′1, . . . R′q to the requests R1, . . . Rq. In an embodiment, the load testing system 5 includes machine readable instructions stored on a non-transitory machine readable medium of the user equipment 6 for measuring the response times (or for causing the user equipment 6 to measure the response times) and generating the report.

According to a step 15, the response times measured are compared with the threshold response times predefined in step 10. In an embodiment, the comparison step is carried out using machine executable instructions stored on a non-transitory readable machine medium of the user equipment 6.

If the response times measured are lower than or equal to the predefined threshold response times, then it is considered that the user experience is at least as good as the desired threshold user experience. This means that the initial amount of available resources, deductible and calculated from the initial amount of consumed resources according to step 11, is sufficient to allow a quality user experience. In this case, a test report comprising the test results, and especially a calculated amount of available resources, is generated according to a step 16, and filed according to a step 17. The method is completed.

If the measured response times are greater than the predefined threshold response times, then it is considered that the user experience is less good than the desired threshold user experience. This means that the initial amount of available resources, deductible and calculated from the initial amount of consumed resources according to step 11, is insufficient to allow a quality user experience. In this case, according to a step 18, the resource consumption of the test infrastructure 1 is decreased, in order to improve the user experience. Then, steps 13, 14 and 15 are reiterated: the load testing scenario is launched again, a new load testing report is generated by the load testing system 5, and the new measured response times are compared with the predefined threshold response times in step 10. If the new measured response times are lower than or equal to the predefined threshold response times, then step 16 and step 17 are performed. Otherwise, the resource consumption of the test infrastructure 1 is again decreased, until an amount of available resources is obtained such that the response times measured are lower than or equal to the predefined threshold response times.

This method enables the drift of the response times, and therefore of the user experience to be observed, as a function of the evolution of the resource consumption.

It will be appreciated that the invention is not limited to the embodiment described in reference to the figures, and alternatives can be contemplated without departing from the scope of the invention.

In particular, it will be appreciated by one skilled in the art that the disclosed method described herein represents a solution to the technological problem currently faced by designers for determining which quantity of available resources on the infrastructure enables a certain level of user experience to be ensured.

The invention is not restricted to the embodiments of equipments described above, only as an example, but it encompasses all the variants that those skilled in the art could envisage solely within the scope of the claims hereafter.

Having described and illustrated the principles of the invention with reference to various embodiments, it will be recognized that the various embodiments can be modified in arrangement and detail without departing from such principles. It should be understood that the devices, modules, processors, processing units, programs, processes, or methods described herein described herein are not related or limited to any particular type of computing environment, unless indicated otherwise. Various types of specialized computing environments may be used with or perform operations in accordance with the teachings described herein. Elements of embodiments shown in software may be implemented in hardware and vice versa.

Execution of the sequences of machine instructions contained in the memory causes the processor or processing unit to perform at least some of the process steps, calculations or function(s) of the procedures and methods described herein. One or more physical processors or physical processing units in a multi-processing arrangement may also be employed to execute the sequences of instructions contained in the memory or machine/computer readable medium. In alternative embodiments, hard-wired circuitry may be used in place of or in combination with software instructions.

The term “computer readable medium” or “machine readable medium” as used herein refers to any medium that participates in providing instructions to a processor or processing unit for execution. Such a medium is non-transitory and may take many forms, including but not limited to, non-volatile media, volatile media, and transmission media. Non-volatile media include, for example, optical or magnetic disks. Volatile media include dynamic memory. Transmission media include coaxial cables, copper wire and fiber optics. Common forms of computer/machine readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer/machine readable media may be involved in carrying one or more sequences of one or more instructions to processor for execution.

1. A method for determining an amount of available resources of a production computing infrastructure, said amount of available resources ensuring a predetermined level of user experience associated with a computing application, the computing application being intended to be released on said production infrastructure, the method comprising:
A: consuming an initial amount of resources of a test infrastructure, on which the application is installed;
B: running a load testing scenario, during which a plurality of requests are sent to the computing application installed on the test infrastructure;
C: measuring a parameter quantising the user experience, as a function of a scenario report including data relating to responses to said requests;
D: if the measured parameter is lower than the predetermined level of user experience: decreasing the resource consumption of the test infrastructure, and then reiterating steps B, C and D, and
E: calculating the amount of available resources ensuring the predetermined level of user experience, as a function of an amount of consumed resources for which the measured parameter is higher than or equal to the predetermined level of user experience, and of a total amount of resources of the production infrastructure.

2. The method according to claim 1, further comprising a step of determining the initial amount of resources, greater than or equal to an average amount of consumed resources on the production infrastructure.

3. The method according to claim 1, wherein the data relating to the responses to the requests are response times.

4. The method according to claim 1, further comprising a step of comparing the successive parameters measured during each iteration of step D.

5. The method according to claim 1, wherein the amount of consumed resources is decreased by a fraction of the initial amount during step D.

6. The method according to claim 1, wherein step A is performed by running at least one program installed on a user equipment, triggering operations consuming resources of the test infrastructure.

7. The method according to claim 1, further comprising a step of filing the amount of available resources calculated in step E.

8. The method according to claim 1, further comprising a step of generating a test report comprising the amount of available resources calculated in step E.

9. A computer program product implemented on a non-transitory storage medium, comprising machine executable instructions for implementing a method according to claim 1.
